(19) United States
(12) Patent Application Publication
(10) Pub. No.: US 2011/0315642 A1
(43) Pub. Date: Dec. 29, 2011

(54) Movable hidden clothing hanger

(76) Inventor: Joseph T. Gubbrud, Valencia, CA (US)

(21) Appl. No.: 12/803,597

(22) Filed: Jun. 29, 2010

(51) Int. Cl. A47F 7/19; B23P 17/04

(52) U.S. Cl. 211/1.57; 29/428

(57) ABSTRACT

A movable hidden clothing hanger includes a positioning mount for securely mounting on a wall surface at an overhead area, a hanger unit, and a control arrangement operatively coupling between the positioning mount and the hanger unit to selectively move the hanger unit between a hand-reachable position and an above head position. At the hand-reachable position, the hanger unit is dropped down from the positioning mount for enabling the laundry object being hanged at the hanger unit, and at the above head position, the hanger unit is lifted up for suspendedly hanging the laundry object at the overhead area so as to maximize a usage floor area below the hanger unit.

### BACKGROUND OF THE PRESENT INVENTION

1. Field of Invention

The present invention is related to a hanger, and more particularly to a clothing hanger which is able to movably lift up the hanger for hanging clothing above head, so as to utilize an overhead space.

2. Description of Related Arts

In the modern family, it is common that people may conveniently throw the washed clothing into dryer machine for the drying process of the wet clothing. For those delicate garments, the user may have to air dry those garments to prevent the damage from the high temperature of the dryer machine. Due to the rising of environmental awareness, the user may want to hang the clothes or garment for naturally air drying process in order to save the energy.

There have been many designs for hanging the variety of clothes or garment, such as variety of triangular shaped hanger hooks for hanging tops, pants, or underwear up on, so that the clothes are able to be expandably hung thereon for being air dried. Therefore, there are many designs of clothing support or clothing hanger are provided for supportly hanging the hanger hooks with the garment thereon or directly hanging the garment on the clothing support for the natural process of air drying, so as to save the electrical energy consumed by the dryer machine.

One of the common clothing supports for hanging the garment is a clothing stand, which normally has a standing frame fixedly coupling and supporting an elongated hanger bar crossly and horizontally above the ground at a predetermined distance between the hanger bar and the floor, so that the hangers are able to be mounted onto the hanger bar for suspending the clothing or garment in the air.

However, the clothing stand standing on the ground is bulky and wastes lots of free spaces in a limited area, especially in an indoor laundry room or the semi-opened patio. Most of modern family living in a crowded city has limited floor space and confined space of laundry hanging area, such as garage, the laundry room, patio, or basement. In this instance, the clothing stand is not suitable for hanging clothing thereonto to environmentally friendly air dry the clothing, garment, or any other accessories.

Furthermore, the clothing stand for suspending or hanging the clothing or garment thereon needs to match the contours of the environment within the confined and limited area. Therefore, the clothing stand is challenged to both the bulky volume and the shape thereof. Another drawback of the clothing stand is that existing clothing stand or clothing rack can hardly being stored or being out of site when not in use. Therefore, it is hard to blend in to the background of the environment and decreases the aesthetic feelings of the indoor or outdoor decorations. Considering the limited floor space, the clothing stand also has relatively more limited clothing hanging area for holding one or more loads of laundry.

In a compact laundry room in an apartment, for example, the floor space thereof is commonly occupied by both clothing washing machine and the dryer machine, so that there is no spare space for placing the clothing stand for hanging clothing. Even the clothing stand is able to fit into the small laundry room, there might not have adequate walking or working area to cause inconveniency while doing laundry. The clothing stand usually has very limited clothing hanging line or rack in order to form a relatively more compact size thereof, so that even the clothing stand is able to fit into the laundry room, the capacity of the clothing stand may not be able to accommodate one basic load of laundry, so that the user may have to hang the rest of the clothing somewhere else or use the dryer machine, which is energy consuming. Therefore, the user may have to inconveniently bring the washed clothing to somewhere else and suspend the clothing all over in the tiny apartment.

In order to compensate the drawbacks of the clothing stand, a hanger bar may be provided for being fixedly and securely mounted on the ceiling wall of the laundry area, so that no floor space is required for hanging clothing. The air circulation above head near the ceiling area can also further expedite the air dry process of the garment or clothing.

However, this type of hanger bar also rises another concerning. The hanger bar mounted on the ceiling may not be reachable especially for shorter adults or children. An assisting tool, such as elongated extending arm or ladder, may be necessary provided for hanging the clothing or the hanger hooks on the hanger bar above head. Therefore, it is inconvenient for suspending the clothing or other accessories onto the hanger bar.

### SUMMARY OF THE PRESENT INVENTION

The invention is advantageous in that it provides a movable hidden clothing hanger for utilizing an overhead area of clothing zone, so as to maximize a usage floor area below the movable hidden clothing hanger.

Another advantage of the invention is to provide a movable hidden clothing hanger which is able to movably adjust the height of the clothes hanger between an above head position for storing or air drying the suspended clothing or garment thereon and a hand-reachable position for hanging or taking off the clothing or garment suspended on the clothing hanger.

Another advantage of the invention is to provide a movable hidden clothing hanger, wherein the positioning mount is able to securely support the hanger unit on the wall surface such as ceiling wall, a side wall, or surrounding wall in an above head manner. Therefore, the floor space is required for suspending the clothing or garment in the air.

Another advantage of the invention is to provide a movable hidden clothing hanger, wherein the retractable unit is able to selectively adjust the height of the hanger unit for conveniently reaching the hanger unit to hang the clothing or garment.

Another advantage of the invention is to provide a movable hidden clothing hanger, wherein the retractable unit is powered by a motorized unit for conveniently applying minimum amount of force thereto in order to adjust the height of hanger unit.

Another advantage of the invention is to provide a movable hidden clothing hanger, wherein the retractable unit is powered by the motorized unit, so that the height of hanger unit is able to be automatically and electrically adjusted via a control switch.

Another advantage of the invention is to provide a movable hidden clothing hanger, which is able to be flexibly installed in an indoor or outdoor area of the air dry zone, such as outer wall of the house, ceiling wall or side wall of patio, garage, patio, laundry room, or basement.

Another advantage of the invention is to provide a movable hidden clothing hanger, wherein the height of the hanger unit is adjustable between any positions of the above head position and hand-reachable position in accordance to height of the ceiling or the desired height of a user.

Another advantage of the invention is to provide a movable hidden clothing hanger, wherein the hanger unit is capable of hanging a larger load of clothing, garment including any other accessories or fabric or non-fabric objects.

Another advantage of the invention is to provide a movable hidden clothing hanger, wherein the clothing hanger is able to lift up the clothing or garments hung onto the hanger unit to expedite the air drying process.

Another advantage of the invention is to provide a movable hidden clothing hanger, wherein the hanger unit is hidden at the overhead position and is able to be out of sight when not in use.

Additional advantages and features of the invention will become apparent from the description which follows, and may be realized by the following description of the instrumentalities and combinations particular pointing out in the appended claims.

According to the present invention, the foregoing and other objects and advantages are attained by providing a movable hidden clothing hanger, which comprises:

a positioning mount adapted for securely mounting on a wall surface at an overhead area;

a hanger unit adapted for suspendedly hanging a laundry object; and

a control arrangement operatively coupling between the positioning mount and the hanger unit to selectively move the hanger unit between a hand-reachable position and an above head position, wherein at the hand-reachable position, the hanger unit is dropped down from the positioning mount for enabling the laundry object being hanged at the hanger unit, and at the above head position, the hanger unit is lifted up for suspendedly hanging the laundry object at the overhead area so as to maximize a usage floor area below the hanger unit.

In accordance with another aspect of the invention, the present invention comprises a method for of suspendedly hanging the laundry object at an overhead area via the movable hidden clothing hanger, wherein the method comprises the following steps.

(1) Securely mount the positioning mount at the overhead area to support the control arrangement thereat.

(2) Normally retain the hanger unit at an above head position that the hanger unit is lifted up via the control arrangement.

(3) Drop down the hanger unit from the above head position to a hand-reachable position via the control arrangement for enabling the laundry object being hanged at the hanger unit.

(4) Lift up the hanger unit back to the above head position for suspendedly hanging the laundry object at the overhead area so as to maximize a usage floor area below the hanger unit.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a sectional view of the movable hidden clothing hanger according to the above preferred embodiment of the present invention.

FIG. 2A is a schematic drawing of the movable hidden clothing hanger according to the above preferred embodiment of the present invention, illustrating the clothing hanger mounted on a wall, wherein the hanging bar is at the hand reachable position.

FIG. 2B is a schematic drawing of the movable hidden clothing hanger according to the above preferred embodiment of the present invention, illustrating the clothing hanger mounted on a wall, wherein the hanging bar is between the hand reachable position and the overhead position.

FIG. 2C is a schematic drawing of the movable hidden clothing hanger according to the above preferred embodiment of the present invention, illustrating the clothing hanger mounted on a wall, wherein the hanging bar is at the overhead position.

FIG. 3 illustrates an alternative mode of the retractable unit and the positioning mount of the movable hidden clothing hanger according to the above preferred embodiment of the present invention.

FIG. 4 illustrates an alternative mode of the hanger unit of the movable hidden clothing hanger according to the above preferred embodiment of the present invention.

FIG. 5 illustrates another alternative mode of the hanger unit of the movable hidden clothing hanger according to the preferred embodiment of the present invention.

### DETAILED DESCRIPTION OF THE PREFERRED EMBODIMENT

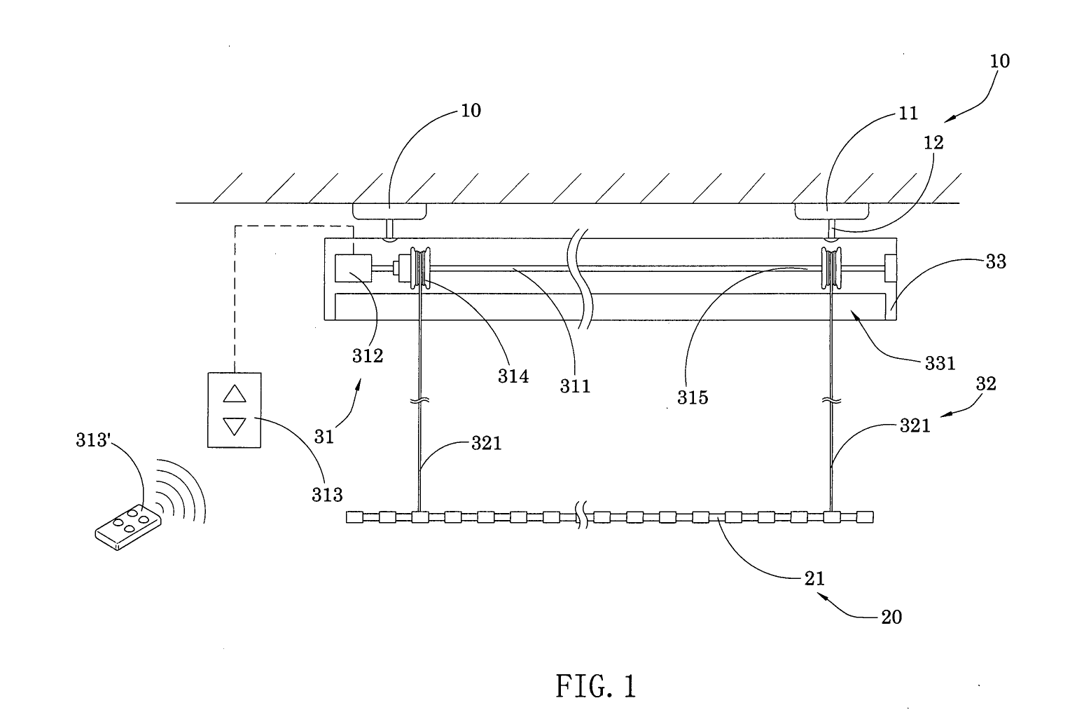

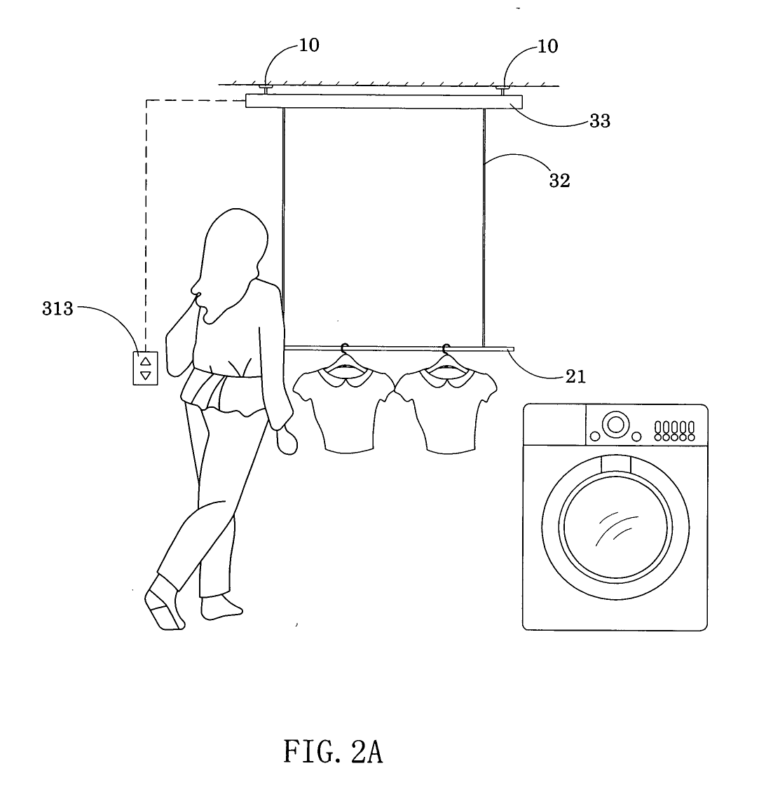

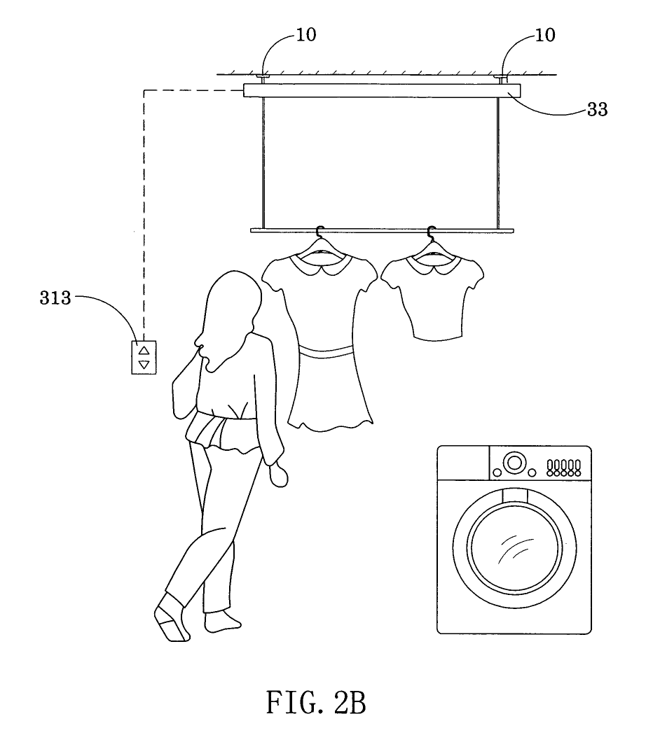

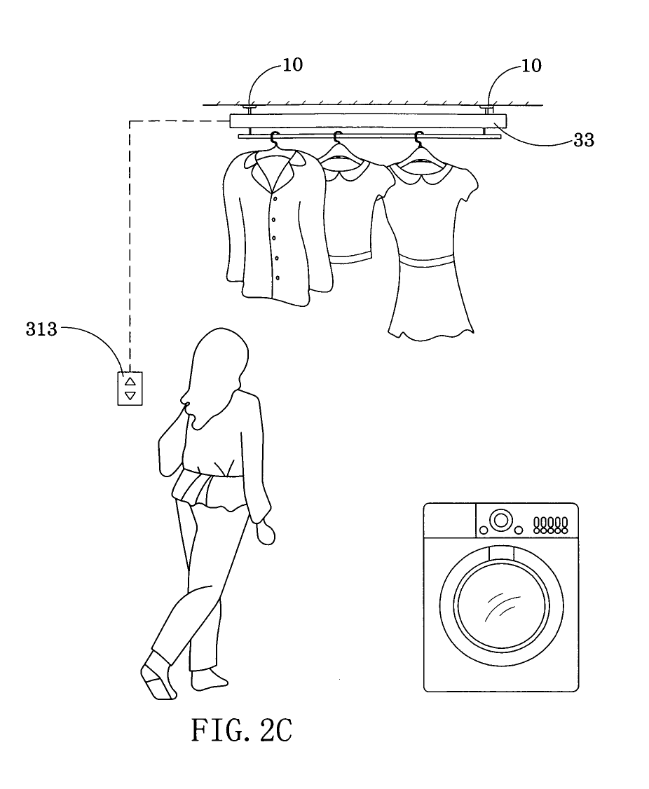

Referring to FIGS. 1, 2A, 2B, and 2C of the drawings, a movable hidden clothing hanger according to a preferred embodiment of the present invention is illustrated, wherein the movable hidden clothing hanger comprises a positioning mount 10 adapted for securely mounting on a wall surface at an overhead area, a hanger unit 20 adapted for suspendedly hanging a laundry object, such as clothing, and a control arrangement 30.

According to the preferred embodiment, the control arrangement 30 is operatively coupling between the positioning mount 10 and the hanger unit 20 to selectively move the hanger unit 20 between a hand-reachable position and an above head position, as shown in FIGS. 2A and 2C respectively. Accordingly, at the hand-reachable position, the hanger unit 20 is dropped down from the positioning mount 10 for enabling the laundry object being hanged at the hanger unit 20. At the above head position, the hanger-unit 20 is lifted up for suspendedly hanging the laundry object at the overhead area so as to maximize a usage floor area below the hanger unit 20. It is important to mention that the control arrangement 30 is able to adjustably control the height of the hanger unit 20 between the overhead position and the hand reachable position in accordance with variety of sizes or length of the clothing or garments, as best shown in FIG. 2B.

In other words, the control arrangement 30 is supported by the positioning mount 10 to operatively connect with the hanger unit 20 and movably drive the hanger unit 20 moving in an up and down direction, so as to adjustably support the hanger unit 20 at the above head position to utilize the overhead area.

At the hand-reachable position, which is the lowest position of the hanger unit 20, the hanger unit 20 is lowered to the predetermined height such that a user is able to easier access the garment being hung or suspended on the hanger unit 20. At the above head position, the hanger unit 20 is lifted up at a height that the hanger unit 20 is stored at the overhead area for being substantially out of site in a hidden manner. Or the hanger unit 20 is lifted up at the upper position at the above head position for hanging the garment thereon in the overhead manner for storing the garment or for air drying thereof.

Accordingly, the positioning mount 10 is preferably secured at a wall in an indoor or outdoor area for hanging or suspending garment as the laundry object, which may include clothing, any fabric or non fabric objects, or accessories. The wall could be the side wall or ceiling wall of a laundry room, bedroom, patio, or any other indoor or outdoor area for suspending garment. The positioning mount 10 is mounted on the wall at an overhead position, so that the hanger unit 20 is able to be movably supported at an uppermost position, i.e. the above head position, for hanging garment via the positioning mount 10.

As shown in FIG. 1, the positioning mount 10 is embodied as a ceiling mount for securely mounting at a ceiling wall to suspendedly hang the hanger unit 20 under the ceiling wall. The positioning mount 10 comprises a mounting base 11 affixed to the ceiling wall and a supporting arm 12 downwardly extended from the mounting base 11 to support the control arrangement 30 below the ceiling wall.

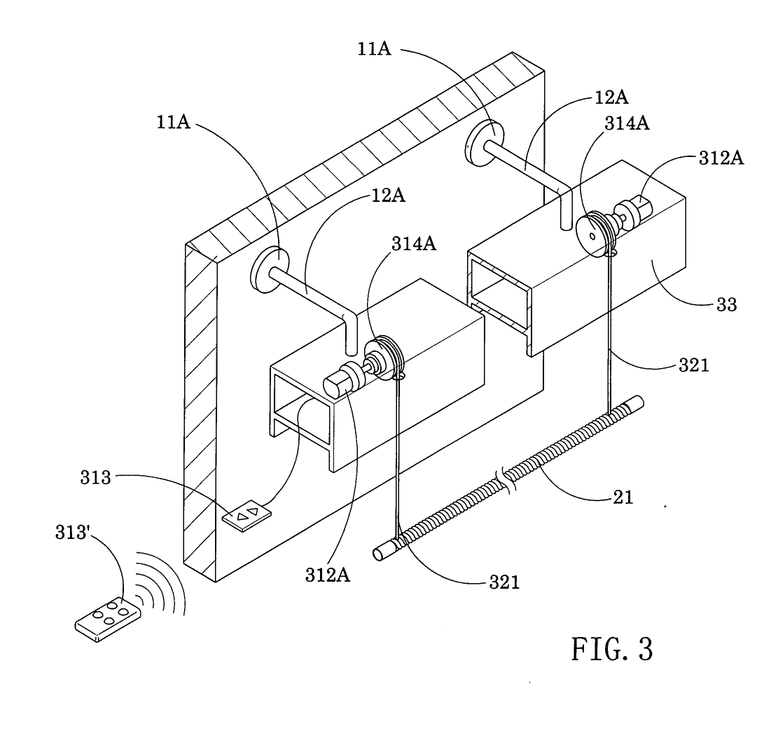

Alternatively, the positioning mount 10A can be a wall mount having a L-shaped configuration adapted for securely mounting at a drywall to suspendedly hang the hanger unit 10 away from the drywall, as shown in FIG. 3. Likewise, the positioning mount 10A comprises a mounting base 11A affixed to the drywall and a L-shaped supporting arm 12A outwardly extended from the mounting base 11A to support the control arrangement 30 away from the drywall. It is appreciated that the positioning mount 10 may be mounted on any other mounting rack for the positioning mount 10 being mounted thereon at the overhead area, so as to support the hanger unit 20 at the above head position.

As shown in FIG. 1, the hanger unit 20 comprises an elongated hanging bar 21 horizontally and suspendedly supported the positioning mount 10 in a vertically movable manner. Therefore, the hanging bar 21 can be vertically lifted up towards the positioning mount 10 via said control arrangement 30 and vertically dropped down away from the positioning mount 10. It is worth to mention that the hanging bar 21 may further has a plurality indented grooves 211 integrally formed thereon for separately positioning the hangers with the garment or clothing spacedly hanging on the hanging bar 21. Therefore, during the operation of lifting up or down the hanging unit 21, the indented grooves 211 are able to prevent the unwanted lateral movements of the hangers. It will be appreciated that the indented grooves 211 may be alternatively formed via forming a threaded portion with a plurality of spirals on the outer surface of the hanging bar 21 for spacedly positioning the hangers hanging thereon, as shown in FIG. 3.

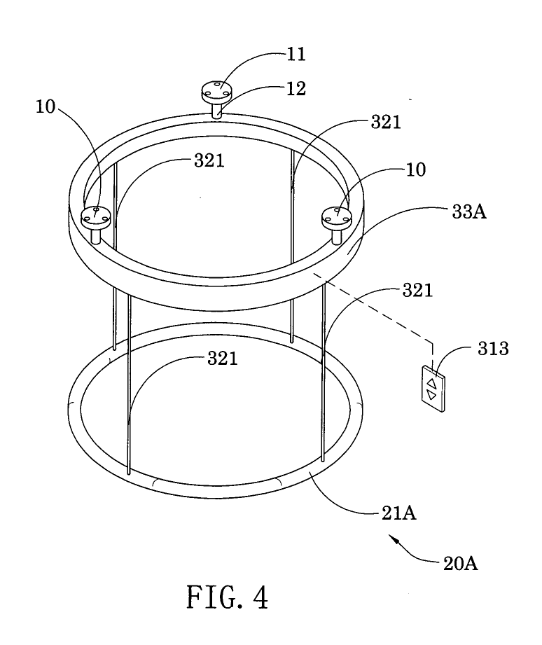

Alternatively, the hanger unit 20A comprises a circular hanging loop 21A horizontally and suspendedly supported the positioning mount 10 in a vertically movable manner, as shown in FIG. 4. Therefore, the hanging loop 21A can be vertically lifted up towards the positioning mount 10 via said control arrangement 30 and vertically dropped down away from the positioning mount 10. It is worth mentioning that the hanging loop 21A can be formed in a rectangular shape, ellipse shape, or circular shape for further enhancing the capacity of the hanger unit 20A to hang the laundry object thereat at 360 degrees manner.

According to the preferred embodiment, the control arrangement 30 comprises a retractable unit 31 supported by the positioning mount 10 and an elongated element 32 extended from the retractable unit 31 to the hanger unit 20 in a controllably retractable manner so as to selectively adjust a height of the hanger unit 20 via a controllable length of the elongated element 32.

The retractable unit 31 comprises an operation shaft 311 operatively coupling with the upper end of the elongated element 32 and a motorized unit 312 operatively coupled with the operation shaft 311 to drive the operation shaft 311 to rotate so as to controllably wind up the elongated element 32. In other words, when the motorized unit 312 is activated for generating a rotational power, the operation shaft 311 is driven to rotate to wind up the elongated element 32 for shortening the controllable length thereof so as to lift up the hanger unit 20. Likewise, when the motorized unit 312 is activated for generating the rotational power with an opposite direction to drive the operation shaft 311 to rotate at the opposite direction, the elongated element 32 is unwound for lengthening the controllable length thereof so as to drop down the hanger unit 20. It will be readily appreciated that the retractable unit 31 may be able to be manually pulled to wind or unwind the elongated element 32, so as to adjust the height of the hanger unit 20 between the above head position and the hand-reachable position in any conventional retractable fashions. For instance, a handle actuator is operatively connecting with the operation shaft 311 via a gear arrangement for rotatably and reciprocatively manipulating the handle actuator to drive the operation shaft to rotate, in such a manner that the handle actuator is able to wind and unwind the elongated element 32 to manually adjust the height of the hanging bar 21.

As shown in FIG. 1, the elongated element 32 comprises two retractable cables 321 downwardly extending from the retractable unit 31 to couple with two ends of the hanging bar 21 such that when the retractable cables 321 are retracted by the retractable unit 31 to shorten the controlling lengths of the retractable cables 321, the hanging bar 21 is vertically lifted up from the hand-reachable position.

In particular, the upper ends of the retractable cables 321 are coupled at the operation shaft 311 while the lower ends of the retractable cables 321 are coupled at the ends of the hanging bar 21. Therefore, the motorized unit 312 is controllably activated to control the vertical movement of the hanger unit 20 between the hand-reachable position and the above head position for selectively adjusting the height of the hanger unit 20.

It is worth mentioning that two or more retractable cables 321 can be used for suspending the hanger unit 20A in a balancing manner. As shown in FIG. 4, four retractable cables 321 are preferably used for the hanging loop 21A having the circular configuration so as to maintain the balance of the hanging loop 21A being moved between the hand-reachable position and the above head position.

Preferably, the retractable unit 31 further comprises a control switch 313 operatively control the motorized unit 312 in a distance manner. According to the preferred embodiment, the control switch 313 is electrically linked to the motorized unit 312 via an electrical cable. The control switch 313 is preferably affixed at a hand-reachable location that the user is able to easily reach and operate the control switch 313 for controllably adjusting the height of the hanger unit 20. Accordingly, the control switch 313 is operated to control the rotational direction of the operation shaft 311 through the rotational power of the motorized unit 312. Therefore, when the control switch 313 is operated to activate the motorized unit 312 to rotate the operation shaft 311 at one direction, the hanger unit 20 is automatically lifted to the above head position. When the control switch 313 is operated to activate the motorized unit 312 to rotate the operation shaft 311 at an opposed direction, the hanger unit 20 is automatically dropped to the hand-reachable position. It is appreciated that a remote controller 313′ may be further provided for wirelessly and electrically linking to the motorized unit 312 or the control switch 313 for remotely adjusting the height of the hanger unit 20.

More specifically, the control switch 313 has two control interfaces, which are embodied as an “UP” key and a “DOWN” key, for the user to operate. The user is able to easily control the height of the hanger unit 20 by holding the “UP” key to lift up the hanger unit 20 or by holding the “DOWN” key to drop up the hanger unit 20. Preferably, when the user stops pressing one of the keys, the movement of the hanger unit 20 will be simultaneously stopped at a desired height. Alternatively, the user is able to selectively control the hanger unit 20 between the hand-reachable position and the above head position that when the “UP” key is pressed once, the hanger unit 20 will be automatically lifted to the above head position and when the “DOWN” key is pressed once, the hanger unit 20 will be automatically dropped to the hand-reachable position.

According to the preferred embodiment, the control arrangement 30 further comprises a receiving housing 33 having a hidden cavity 331 to receive the hanging bar 21 in a hidden manner when the hanging bar 21 is lifted at the above head position. As shown in FIG. 1, the receiving housing 33 has a length longer than the hanging bar 21 and defines an elongated bottom opening facing downwardly to align with the hanging bar 21. Therefore, when the hanging bar 21 is lifted upwardly, the hanging bar 21 can be entirely received in the hidden cavity 331 of the receiving housing 33 through the bottom opening. It is worth mentioning that the operation shaft 311 is longitudinally received in the hidden cavity 331 and the motorized unit 312 is supported at one side portion of the receiving housing 33 so as to keep the aesthetic appearance of the movable hidden clothing hanger of the present invention.

It is worth mentioning that the size and shape of the receiving housing 33 is configured to match with the size and shape of the hanger unit 20A. For example, when the hanging loop 21A of the hanger unit 20A has a circular configuration, as shown in FIG. 4, the receiving housing 33A is configured to match with the hanging loop 21A to fit the hanging loop 21A in the receiving housing 33A in a hidden manner when the hanging loop 21A is moved at the above head position.

In order to enhance the movement of the hanger unit 20, the retractable unit 31 further comprises a driving roller 314 coaxially coupled at the operation shaft 311 to couple with the upper end of one of the retractable cables 321, and a driven roller 315 coaxially coupled at the operation shaft 311 to couple with the upper end of another retractable cable 321 to wind and unwind the retractable cables 321 in a synchronous manner, as shown in FIG. 1.

Accordingly, the driving roller 314 is operatively coupled with the output axle of the motorized unit 312 via a gear unit such that the rotational power at the output axle of the motorized unit 312 can be efficiently transferred to the driving roller 314 through the gear unit so as to drive the operation shaft 311 to rotate. Then, the driven roller 315 will be rotated through the rotational movement of the operation shaft 311.

Preferably, each of the driving roller 314 and the driven roller 315 has a pulley configuration with a predetermined diameter larger than a diameter of the operation shaft 311. Therefore, when the driving roller 314 and the driven roller 315 are driven to rotate through the rotational movement of the operation shaft 311, the retractable cables 321 can be winded or unwound at the driving roller 314 and the driven roller 315 respectively so as to efficiently control height of the hanger unit 20 in a synchronous and speedy manner.

FIG. 3 also illustrates an alternative mode of the retractable unit 31A which comprises two motorized units 312A to controllably wind up the elongated element 32, wherein the operation shaft 311 can be omitted in the FIG. 3. In particular, the upper ends of the retractable cables 321 are coupled at the motorized units 312A respectively while the lower ends of the retractable cables 321 are coupled at the ends of the hanging bar 21 respectively. Therefore, the motorized units 312A are controllably activated in a synchronous manner via the control switch 313 to control the vertical movement of the hanger unit 20 between the hand-reachable position and the above head position for selectively adjusting the height of the hanger unit 20.

In particular, the driver rollers 314A are operatively coupled with the output axles of the motorized units 312A respectively to couple with the upper ends of the retractable cables 321. Therefore, the motorized units 312A provide two rotational powers such that the hanger unit 20 with heavier laundry objects can be lifted up and dropped down.

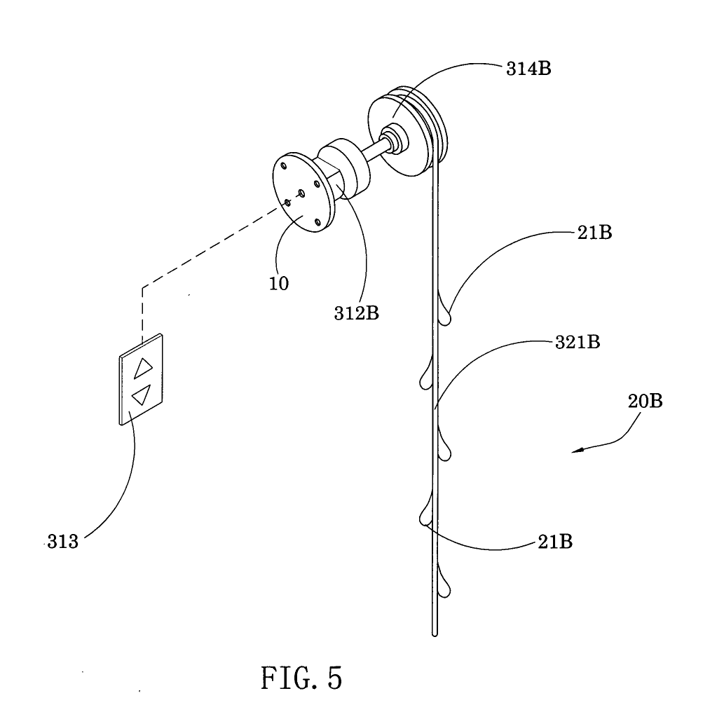

FIG. 5 further illustrates another alternative mode of the retractable unit 31B which comprises a motorized unit 312B to controllably wind up the elongated element 32B, wherein the operation shaft 311 can be omitted in the FIG. 5. The retractable unit 31B further comprises a driver roller 314B operatively coupled with the output axle of the motorized unit 312B respectively to couple with the upper end of the retractable cable 321B such that when the motorized unit 312B is activated, the retractable cable 321B can be winded or unwound at the driver roller 314B.

In addition, the hanger unit 20B comprises a plurality of hanging loops 21B spacedly provided at the lower portion of the retractable cable 321B for suspendedly hanging the laundry object along the retractable cable 321B via the clothes hangers. This simple configuration provides a single motorized unit 312 such that the hanger unit 20 with lighter laundry objects can be lifted up and dropped down.

In order to operate the movable hidden clothing hanger of the present invention to suspendedly hang the laundry object at an overhead area, the user is able to securely mount the positioning mount 10 at the desired overhead area to support the control arrangement 30 thereat. For example, the positioning mount 10 can be fixed at the ceiling wall above the washing machine as shown in FIG. 2.

At the initial position, the hanger unit 20 is normally retained at an above head position that the hanger unit 20 is lifted up via the control arrangement 30 and is received in the receiving housing 33 in a hidden manner. Then, by wiring the control switch 313 at a desired hand-reachable location, the user is able to operate the hanger unit 20 via the control switch 313.

When the user wants to hang the laundry object, he or she can operate the control switch 313 to drop down the hanger unit 20 from the above head position to the hand-reachable position such that the user can easily reach the hanger unit 20 and hang the laundry object thereat. Once the laundry object is hung, the user is able to operate the control switch 313 to lift up the hanger unit 20 back to the above head position for suspendedly hanging the laundry object at said overhead area so as to maximize a usage floor area below the hanger unit 20.

It should be noted that no matter at the above head position or the hand-reachable position, the hanger unit 20 is normally supported by the positioning mount 10 at the overhead area of any indoor or outdoor space, so as for efficiently saving the limited floor space, such as in the compact laundry room. In this instance, the user is able to adjust the height of the hanger unit 20 to a comfortable position, so that the user can conveniently take out the washed wet garment from the washing machine to directly hang the garment on the hanger unit 20 at the hand-reachable position. After hanging the garment onto the hanger unit 20, the hanger unit 20 is preferably lifted up to the above head position, so that the garment is able to be hung at the overhead area for being naturally air dried. As will be readily appreciated that the garment being hung at a relatively higher position has a better air circulation to expedite the air dry process of the garment.

Alternatively, the hanger unit 20 in the laundry room can also be a temporally transfer working station for the user hanging the machine dried garment with different types of clothes hanger. In other words, the user is able to hang the dried laundry object at the clothes hanger from the dryer machine and temporally hang the clothes hanger at the hanger unit 20. Then, all the laundry objects can be carried with the clothes hangers back to the closet at the same time. Therefore, the movable hidden clothing hanger is able to provide the hanger unit 20 with adjustable height for conveniently hanging the garment thereon, meanwhile, provide the temporally transfer working station to ease the process of dealing the washed garment as mentioned in this instance. Of course, the hanger unit 20 is not only limited to be mounted on the ceiling wall of laundry room. The hanger unit 20 is able to mount in any indoor or outdoor wall for suspending garment or the likes. The user may hang any other object on the hanger unit 20 for any other purposes, such as storing the garment at the overhead area via the clothes hanger of the present invention.

Without the limitation of the floor space, the hanger unit 20 is able to have relatively larger capacity for hanging larger amount of garment thereon. Thereby, the movable hidden clothing hanger of the present invention is able to mount the hanger unit 20 at the overhead area to minimize the occupied space of the clothing hanger, so as to maximize the capacity of the hanger unit 20 for hanging garment thereon.

As will be readily appreciated by one skilled in the art, the embodiment and its alternatives are interchangeable that the positioning mounts 10 and 10A are interchangeable, and the hanger units, 20 20A, and 20B, are interchangeable, and the retractable unit 31, 31A, 31B are also interchangeable. It should be noted that the retractable unit 31 may be able to be manually pulled to wind or unwind the elongated element 32, so as to adjust the height of the hanger unit 20 between the above head position and the hand-reachable position in any conventional retractable fashions.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A movable hidden clothing hanger, comprising:
a positioning mount adapted for securely mounting to a wall surface at an overhead area;
a hanger unit adapted for suspendedly hanging a laundry object; and
a control arrangement operatively coupling between said positioning mount and said hanger unit to selectively move said hanger unit between a hand-reachable position and an above head position, wherein at said hand-reachable position, said hanger unit is dropped down from said positioning mount for enabling said laundry object being hanged at said hanger unit, and at said above head position, said hanger unit is lifted up for suspendedly hanging said laundry object at said overhead area so as to maximize a usage floor area below said hanger unit.

2. The movable hidden clothing hanger, as recited in claim 1, wherein said control arrangement comprises a retractable unit supported by said positioning mount and an elongated element extended from said retractable unit to said hanger unit in a controllably retractable manner so as to selectively adjust a height of said hanger unit via a controllable length of said elongated element.

3. The movable hidden clothing hanger, as recited in claim 1, wherein said hanger unit comprises an elongated hanging bar horizontally and suspendedly supported below said positioning mount in a vertically movable manner via said control arrangement.

4. The movable hidden clothing hanger, as recited in claim 2, wherein said hanger unit comprises an elongated hanging bar horizontally and suspendedly supported below said positioning mount in a vertically movable manner via said control arrangement.

5. The movable hidden clothing hanger, as recited in claim 4, wherein said elongated element comprises two retractable cables downwardly extending from said retractable unit to couple with two ends of said hanging bar such that when said retractable cables are retracted by said retractable unit to shorten said controlling lengths of said retractable cables, said hanging bar is vertically lifted up from said hand-reachable position.

6. The movable hidden clothing hanger, as recited in claim 5, wherein said retractable unit comprises an operation shaft operatively coupling with upper ends of said retractable cables and a motorized unit operatively coupled with said operation shaft to drive said operation shaft to rotate so as to controllably wind up said retractable cables at said operation shaft to lift up said hanger unit and to unwind up said retractable cables at said operation shaft to drop up said hanger unit.

7. The movable hidden clothing hanger, as recited in claim 6, wherein said retractable unit further comprises a driving roller coaxially coupled at said operation shaft to couple with said upper end of one of said retractable cables, and a driven roller coaxially coupled at said operation shaft to couple with said upper end of said another retractable cable to wind and unwind said retractable cables in a synchronous manner.

8. The movable hidden clothing hanger, as recited in claim 6, wherein said retractable unit further comprises a control switch operatively control said motorized unit in a distance manner.

9. The movable hidden clothing hanger, as recited in claim 7, wherein said retractable unit further comprises a control switch operatively control said motorized unit in a distance manner.

10. The movable hidden clothing hanger, as recited in claim 3, wherein said control arrangement further comprises a receiving housing having a hidden cavity to receive said hanging bar in a hidden manner when said hanging bar is lifted at said above head position.

11. The movable hidden clothing hanger, as recited in claim 7, wherein said control arrangement further comprises a receiving housing having a hidden cavity to receive said hanging bar in a hidden manner when said hanging bar is lifted at said above head position.

12. The movable hidden clothing hanger, as recited in claim 9, wherein said control arrangement further comprises a receiving housing having a hidden cavity to receive said hanging bar in a hidden manner when said hanging bar is lifted at said above head position.

13. The movable hidden clothing hanger, as recited in claim 1, wherein said positioning mount is a ceiling mount adapted for securely mounting at a ceiling wall to suspendedly hang said hanger unit under the ceiling wall.

14. The movable hidden clothing hanger, as recited in claim 12, wherein said positioning mount is a ceiling mount adapted for securely mounting at a ceiling wall to suspendedly hang said hanger unit under the ceiling wall.

15. The movable hidden clothing hanger, as recited in claim 1, wherein said positioning mount is a wall mount having a L-shaped configuration adapted for securely mounting at a drywall to suspendedly hang said hanger unit away from the drywall.

16. The movable hidden clothing hanger, as recited in claim 12, wherein said positioning mount is a wall mount having a L-shaped configuration adapted for securely mounting at a drywall to suspendedly hang said hanger unit away from the drywall.

17. A method of suspendedly hanging a laundry object at an overhead area via a movable hidden clothing hanger which comprises a positioning mount, a hanger unit, and a control arrangement, wherein the method comprises the steps of:
(a) securely mounting said positioning mount at the overhead area to support said control arrangement thereat;
(b) normally retaining said hanger unit at an above head position that said hanger unit is lifted up via said control arrangement;
(c) dropping down said hanger unit from said above head position to a hand-reachable position via said control arrangement for enabling the laundry object being hanged at said hanger unit; and
(d) lifting up said hanger unit back to said above head position for suspendedly hanging said laundry object at said overhead area so as to maximize a usage floor area below said hanger unit.

18. The method, as recited in claim 17, wherein said hanger unit is actuated to lift up and drop down by said control arrangement via a motorized unit and a control switch.

19. The method as recited in claim 17 wherein, in the step (b), said hanger unit is received in a receiving housing of said control arrangement in a hidden manner.

20. The method as recited in claim 18 wherein, in the step (b), said hanger unit is received in a receiving housing of said control arrangement in a hidden manner.

21. The method as recited in claim 17 wherein, in the step (a), said positioning mount is a ceiling mount for securely mounting at a ceiling wall to suspendedly hang said hanger unit under the ceiling wall.

22. The method as recited in claim 20 wherein, in the step (a), said positioning mount is a ceiling mount for securely mounting at a ceiling wall to suspendedly hang said hanger unit under the ceiling wall.

23. The method as recited in claim 17 wherein, in the step (a), said positioning mount is a wall mount having a L-shaped configuration for securely mounting at a drywall to suspendedly hang said hanger unit away from the drywall.

24. The method as recited in claim 20 wherein, in the step (a), said positioning mount is a wall mount having a L-shaped configuration for securely mounting at a drywall to suspendedly hang said hanger unit away from the drywall.
